(19) United States
(12) Patent Application Publication
(10) Pub. No.: US 2007/0242421 A1
(43) Pub. Date: Oct. 18, 2007

(54) FOLDING COMPUTER

(76) Inventors: Norbert Goschin, Frankfurt (DE); Gerhard Brunnbauer, Frankfurt (DE)

Correspondence Address: THELEN REID BROWN RAYSMAN & STEINER LLP, 2225 EAST BAYSHORE ROAD, SUITE 210, PALO ALTO, CA, 94303, US

(21) Appl. No.: 11/536,699

(22) Filed: Sep. 29, 2006

(30) Foreign Application Priority Data
Apr. 6, 2006 (DE) 20 2006 005 761.7

(51) Int. Cl. G06F 1/16; G06F 3/041

(52) U.S. Cl. 361/681; 345/173

(57) ABSTRACT

Mobile computer, comprising two casing parts, which are connected by a hinge, so that the casing parts can be opened and closed. Each of the casing parts has an input-sensitive flat screen. The casing parts are arranged in such a way as to enable at least two operating modes. As a result, this invention can be used in at least to different operating modes, which can be selected depending on the application. In the preferred embodiment, the invention can be locked in various open positions by way of a flap mechanism.

The invention relates to a folding computer, in particular to a mobile dual screen tablet PC (MDST) with at least two different operating modes.

### SCOPE OF INVENTION

In the area of mobile PC's, there is a series of different models. On the one hand, there are the known laptops, which can be folded or flipped open. They have two casing parts connected by a hinge, wherein one part accommodates the keyboard and primary components, such as the hard disk, processor and memory, while the other casing part, which is preferably flatter, incorporates a flat screen or LCD monitor, or TFT monitor.

On the other hand, there are tablet PC's, in which the screen can be used as the input medium, thereby eliminating the need for a keyboard, or having it disappear under the screen when the monitor is folded over the keyboard. In some models, the monitor can be turned and flipped open again, exposing the keyboard, and enabling use as a laptop. In these devices, the monitor is a touch screen (so called “convertible” PC).

However, the problem with both devices involves achieving an even greater display surface or enabling an even more flexible application.

### OVERVIEW OF THE PRESENT INVENTION

The object of this invention is to overcome the described disadvantages.

This object is achieved by an invention with the features in the independent claims.

In particular by a mobile computer comprising two casing parts connected by a hinge, so that the casing parts can be opened and closed. Each of the casing parts has an input-sensitive flat screen. The casing parts are arranged in such a way as to enable at least two operating modes. As a result, this invention can be used in at least two different operating modes, which can be selected depending on the application. The invention in the preferred embodiment can here be locked into various open positions by way of a flap mechanism.

The operating modes will be described below:

a. Since the casing parts and their corresponding flat screens are preferably rectangular, the device can be opened in mode a, the book mode, and can either stand in an upright position or be used lying flat. To this end, the device can preferably be locked in two positions. On the one hand, in an approx. 180 degree open position relative to the flat/planar condition, or in an approx. 135 degree open position for use like a handheld book.

b. In mode b, the laptop mode, the device is opened like a laptop (transverse position, approx. 115 degrees), turning the right flat screen or touch screen into the upper display screen, and the left touch screen into the underlying input screen. (In the model for left-handed individuals, the arrangement is opposite). In this case, the lower casing half automatically displays a keyboard, which preferably corresponds to the layout of a normal or ergonomic keyboard. In addition, the keyboard can have as many key symbols as desired to display the characters of non-Latin languages, or be labeled with symbols for analphabets. Depending on the language selection for the operating system, various symbols can be displayed on the keyboard, resulting in a uniform hardware design. Further, the screen can exhibit haptically detectable markings, so that the user can feel where the starting position or initial position for the keyboard is. For example, the area of letters “F” and “J” can have an elevation, just as in normal keyboards. However, it is also conceivable to provide even more elevations, as desired by the user. These could be introduced after the fact, for example. It is also conceivable that these elevations be generated by electrical voltage, e.g., in the form of bubbles under a film.

In a possible embodiment, the two touch screens also have varying input technologies that reflect their primary use. (e.g., right-handed individuals).

A (left)-resistive technology in 4, 5 or 8-wire technology is conceivable for input using the finger or any other object, for example. Of course, other technologies are conceivable and usable. The described technology is not intended to be limiting, but serve only as an example. In contrast, a (right)-capacitive technology is also conceivable for input via pen.

This invention has an integrated (replaceable) battery along with a flip frame concept, which makes it possible to operate any devices like optical or magnetic drive, as well as like an additional battery. This enables very long operating times without having to be plugged in to a power source. One important aspect here is that both casing parts are large enough that they can incorporate components of a PC. For example, it is conceivable that the one casing part accommodate the motherboard, memory and, if necessary, a hard disk, while the other side contain the batteries, optical drives or other hard disk drives. As a result, it makes sense to concentrate the weight preferably in the lower casing half relative to mode b, so that the device has a solid footing and will not tilt back over the upper casing part. Therefore, the batteries and drives, like the optical drives or hard disks, and the power supply should be incorporated in this casing part. However, it must be remembered that the weight for mode a cannot be arranged too far in the upper area of the two casing parts, but shifted more in the lower part, so that the device according to the invention can also be used as a book, and does not tend to tip over easily. Hence, the hard disk should be located in the lower middle area of the left casing part (viewed in mode a, book configuration), and the heavy batteries should also be located in the lower area of the casing on the right side.

The two touch screens can be independently controlled and adjusted. For example, the horizontal/vertical orientation, standby mode, background and keyboard display can be controlled separately from each other, providing the highest possible flexibility, along with the highest possible efficiency. The individual modes can preferably be determined by switches placed in the edge area of the casing. For example, a monitor can be turned off when the device is operated only in the display mode (films, video or slide show). This increases the battery life. The screen content can also be aligned or turned by means of a switch. The keyboard can also be displayed or hidden variably by means of a switch. In some cases, it is advantageous for part of the system to exhibit a higher resolution than the other, in particular when fine graphics are to be displayed. This can also be done by means of software in the system, or a switch.

Another component involves an integrated system bus interface for using a docking system with external devices or communication services, which makes it possible to expand upon this invention as desired.

Any external devices can be hooked up via the standard interfaces (keyboard, printer, mouse, scanner, web cam, photo, etc.). The integrated camera enables the use of image transfer services, e.g., as in the telephone via VoIP or video conferencing. This camera is preferably arranged in the edge area of the casing parts next to the displays, wherein accommodation in a corner region of the upper display (mode b) permits operation in both modes.

The integrated communication functions (WLAN, Bluetooth, Ethernet, etc.) provide network services and telecommunication services. As an option, a telephone can be integrated into the casing (chip on motherboard/display on cover) or a mobile telephone can be inserted into the outer cover (insertion compartment with PC port) and used for telecommunication services (GPRS, UMTS and other services). The display variant can here take the form of audio/video files, even without starting up the operating system.

Several exemplary applications will be described below.

In book mode (a), single/double sided document formats, e.g., books, operating instructions, office documents, etc., can be read and processed. Interactive handling of text books or other e-learning materials is conceivable.

In general, any form of man-machine interaction in which work is performed with two open application windows (both respectively active or passive) is possible.

The laptop mode allows the input of notes and sketches by pen (or similar instrument, e.g., drawing board), input of texts via software keyboard (horizontal or vertical), handwriting recognition, external devices (e.g., keyboard, etc.), voice input, display or input on the upper display screen, display of all media (audio, video, slides, presentation documents), etc.) in the full image mode (display on top, control on bottom).

This provides for a mobile device with 2 screens that permits utilization in the book or laptop mode, which provides a tablet PC with flip frame concept, and hence a second battery, and that preferably provides two different touch screen technologies in one device. This makes it possible to work parallel in two windows on a single mobile device. Telephone integration in the casing permits unlimited communication. The multi-point locking technology further allows usage of the laptop with touch screen keyboard.

### DESCRIPTION OF FIGURES

The figures will be briefly described below to achieve a better understanding of the invention.

FIG. 1 shows a perspective view of the closed computer;

FIG. 2 shows another perspective view of the closed computer;

FIG. 3 shows the system according to the invention in a perspective view that is open and set up in the book mode;

FIG. 4 shows the systems according to the invention in the laptop mode, wherein the keyboard is displayed on the lower screen;

FIG. 5 shows the outer parts of the system according to the invention, wherein the individual components and casing covers are sketched in;

FIG. 6 shows the integration of telephones into the device according to the invention, wherein the display can also be an audio media player, and the display can be used to show e-mails, news or the system status, e.g., battery charge;

FIG. 7 shows the integration of a telephone.

### PREFERRED EMBODIMENTS

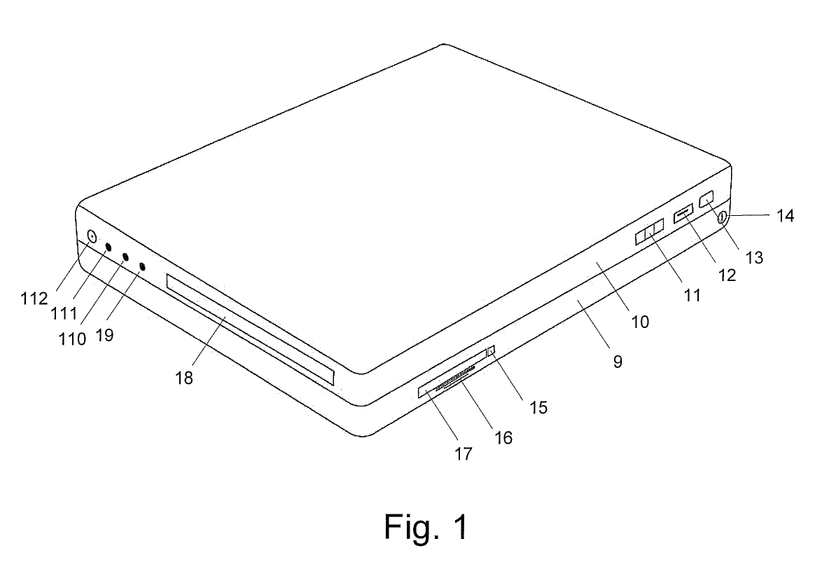

FIG. 1 shows the closed system according to the invention, which has a casing part 9 and casing part 10, wherein casing part 10 is the lower casing part. In addition, the device has a controller with mouse button 11 (jog dial). The latter is preferably not used for actual cursor control, but to navigate within an application, e.g., web browser, book reader, media player. A volume control 12 is used to determine the volume of the speakers in the device and earphone set. Further, there is a button 13 for opening the device, thereby avoiding an unintended opening of the device during transport. Also provided is a pen tether attachment 14, so that a pen can be secured there by means of a tether, allowing its use to control the device without it being lost.

The device also encompasses card slots 16 and 17, which are used to accommodate PC cards, e.g., ExpressCard, PCMCIA, or memory cards, and which can be ejected as needed by pressing an ejection button 15. The battery slot 18 is arranged in the lower casing part in this embodiment, but can also be situated in the upper part, which must be taken into account in each individual case. The battery slot can be opened to change out the battery. A microphone port 19 is used for connecting a corresponding microphone. A sound output 110 is used to output music data, e.g., in digital formats like Dolby surround; of course, alternative formats are conceivable. A headphone port 111 is used for connecting analog headphones. The power supply port 112 is used for power supply. The power supply unit is preferably a separate device with flexible cord.

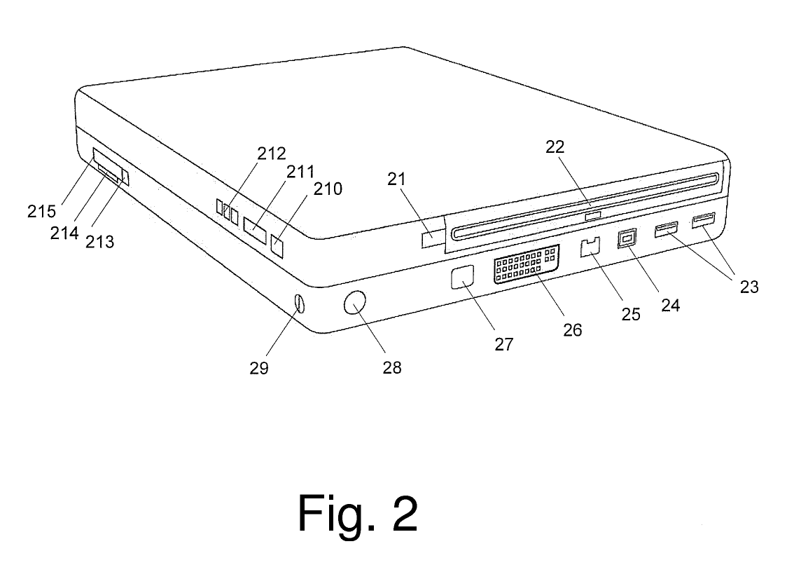

FIG. 2 shows the embodiment from another side, wherein a CD-ROM/DVD drive or second battery 22 are alternatively inserted in the changing frame. Other drives can conceivably be accommodated there, such as hard drives. Also provided is a series of standard ports, such as the USB (alternative: FireWire), port 23, telephone mode port 24, network part 25, DVI port 26 and infrared port 27. The monitor port 26 is designed as a DVI port in this embodiment, but can of course have an analog or other digital format.

Further, there is a pen holder 28, into which the pen for operating the device can be inserted. As already described, the pen tether attachment 29 on FIG. 1 is used to secure the corresponding tether, which is connected with the pen. The button 210 for opening the device was also described. The volume control 211, controller with mouse button 212, ejection button 213 and SD/MMC slot or PC card slot 214, 215 were also described in conjunction with FIG. 1.

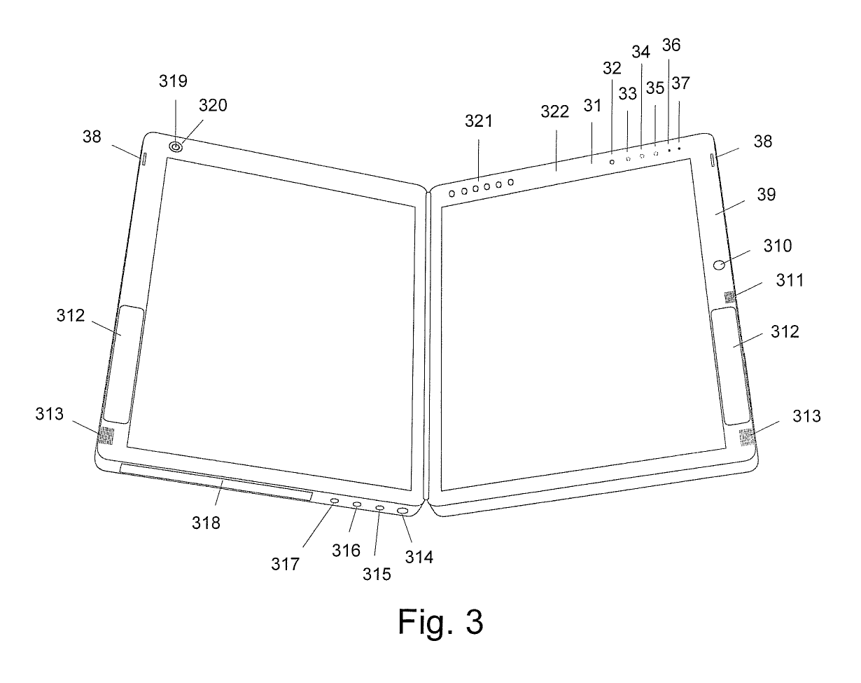

FIG. 3 shows the device in the book mode. Also shown on FIG. 3 is a light sensor 31, with which the brightness of the display can be automatically regulated. For example, when exposed to strong sunlight, the display is usually operated at a brighter setting than in darkness. There is also a status display 32 that indicates whether the WLAN is active. Other LED's are used to indicate that the hard disk is active 33, the CD/DVD drive is active 34 or the Bluetooth is active 35. The ESC key 36 along with the Crtl-Alt-DEL key 37 are configured as actual keys (preferably recessed). Other keys can be used to determine the device mode, e.g., for turning the display on and off, or to fix the rotational direction of the screen content, start whatever programs desired or activate the WLAN service. A latch 38 is used reliably secure the device in the closed position. An antenna 39 is used for connecting with the wireless networks. A camera 310 is arranged in such a way that the user can take pictures of himself in the laptop mode or book mode. Also integrated is a microphone 311, which is situated in the area of the camera to allow voice communication. The hand rest 312 has a special protective design that allows a user to work on the display while placing his hands laterally. The surface of these hand resists is easy to clean, thereby preventing the deposition of dirt particles. In addition, two speakers 313 are preferably provided. The power supply port 314, headphone port 315, sound output 316, microphone port 317, and battery compartment 318 have already been described above. Other constituents include a power on switch 319, as well as a charge status LED 320, which indicates the battery charge status. Also provided are pen-activated function buttons 321 that determine the display rotation, activate the display, turn a keyboard on display on and off, and execute other functions. A Bluetooth antenna 322 is also visible on FIG. 3.

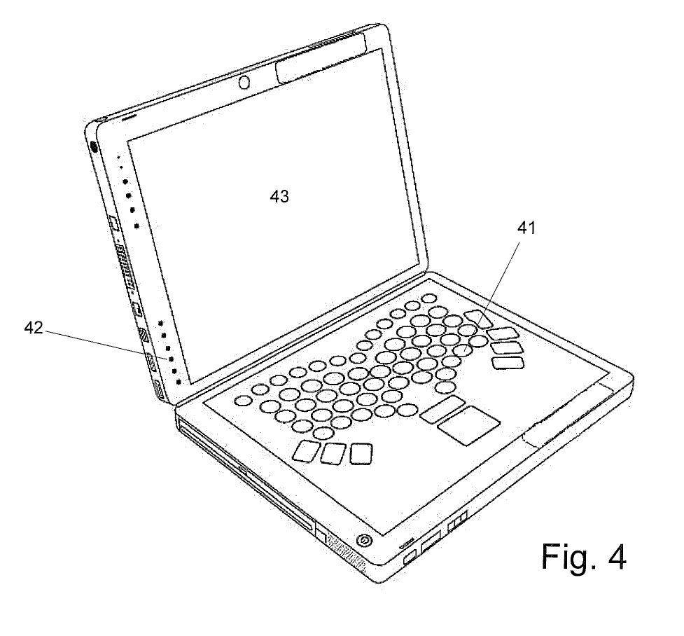

FIG. 4 shows the device in the laptop mode. The keyboard 41 is here presented as an image on the lower screen, and can hence be used as a touch keyboard. Not shown are the markings or bumps that can be haptically touched on the display, and are related to the displayed image or displayed keyboard. The keyboard start button 42 is also shown on FIG. 4. The screen content 43 is now turned by 90° and shown in comparison to FIG. 3.

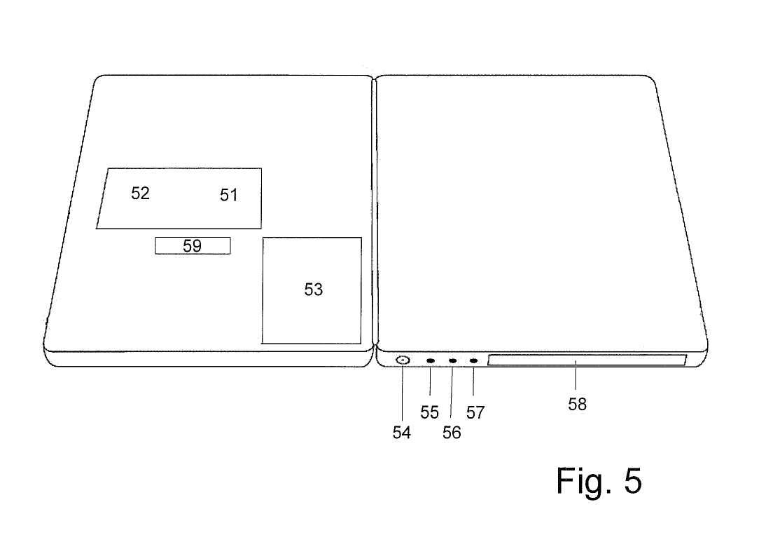

FIG. 5 shows the device in a diagrammatic view from outside, indicating where the individual components are arranged under the casing covers. Clearly evident are the area of the CPU 51 and the cover of the memory modules 52. Also visible is the hard disk cover 53, under which the hard disk is located. The power supply port 54 is situated in the lower casing part, and connected with the preferably external power supply unit. The headphone port 55, the sound output 56 and microphone port 57 are also arranged in the lower casing part. The battery compartment 58 is also located in the lower casing part.

With respect to virtualization, the device can be virtually divided into two separate graphics cards, which each control a display, so that the virtualized computers run physically/logically separated from each other with respect to the graphics cards. These are either two separate cards, or a single graphics card is virtually segmented based on the hardware. As a result, two (possibly different) operating systems can run parallel, and use the entire hardware.

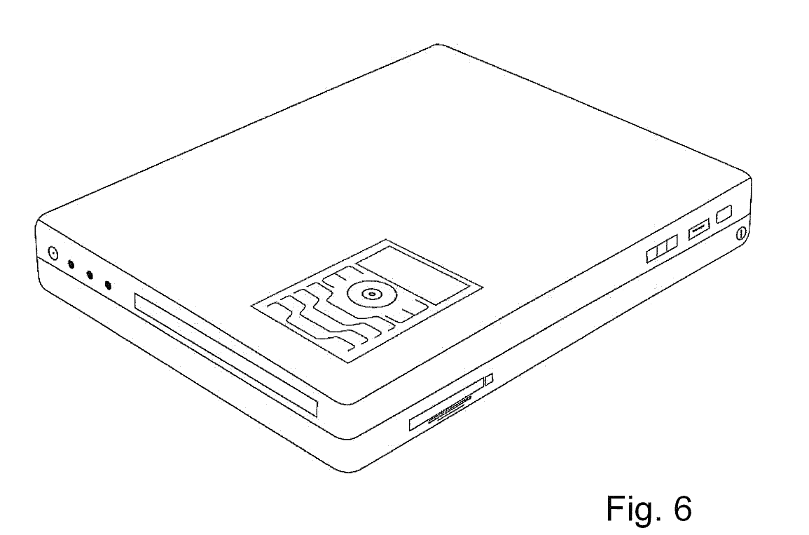

FIG. 6 shows the device according to the invention with another display and integrated telephone keyboard.

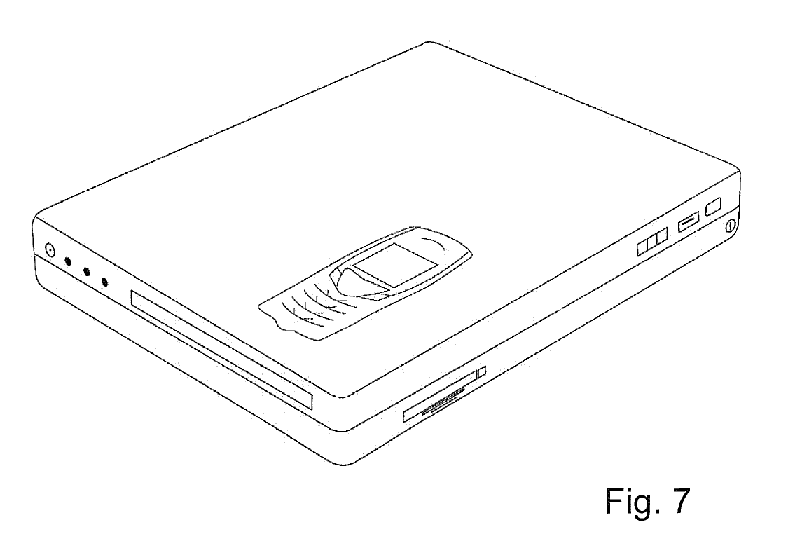

As an alternative, FIG. 7 provides a slot in the casing part, into which ha mobile telephone is inserted. The slot is designed in such a way that replaceable adapter carriages for various mobile telephones are integrated in a first step, and then can accommodate the telephones.

The preferred embodiments do not impose any restrictions. Rather, they elucidate the invention, the scope of protection of which is determined by the following claims.

### REFERENCE LIST

9. Casing part 1
10. Casing part 2
11. Controller with mouse button
12. Volume control
13. Open button
14. Pen tether attachment
15. Ejection button
16 SD/MMC slot
17. Express Card slot
18. Battery compartment
19. Microphone port
110. Sound output
111. Headphone port
112. Power supply port
21. Changing frame lock
22. CD-ROM/DVD or 2nd battery in changing frame
23. USB (alternative: FireWire) port
24. Telephone modem
25. LAN Ethernet port
26. DVI port
27. Infrared
28. Pen holder
29. Pen tether attachment
210. Open button
211. Volume control
212. Control function with mouse button
213. Ejection button
214. SD/MMC slot
215. Express Card slot
31. Light sensor
32. WLAN active LED
33. Hard disk active LED
34. CD/DVD active LED
35. Bluetooth active LED
36. ESC key
37. Crtl+Alt+Del key
38. Latch
39. WLAN antenna
310. Camera
311. Microphone
312. Hand rest
313. Speaker
314. Power supply port
315. Headphone port
316. Sound output
317. Microphone port
318. Battery compartment
319. Power on switch
320. Charge status LED
321. Pen-activated function buttons
322. Bluetooth antenna
41. Keyboard on screen (touch screen)
42. Keyboard start button
43. Right screen turned (90°)
51. CPU cover
52. Memory chip cover
53. Hard disk cover
54. Power supply port
55. Headphone port
56. Sound output
57. Microphone port
58. Battery compartment

1. A mobile computer, comprising:
two casing parts connected by a hinge, so that the casing parts can be opened and closed;
each of the casing parts has an input-sensitive flat screen, which is arranged and controlled in such a way as to enable at least two operating modes, specifically:
a. a book mode in which the two flats screens stand in an upright position, and the information on the flat screen is turned in such a way as to be displayed on a left and right flat screen, in book format;
b. a laptop mode in which the display is transversely situated, just like a laptop that is opened, as a result of which the right/left flat screen becomes the upper display screen, and the left/right flat screen becomes the lower input screen, and the information are turned in such a way that they can be read on the upper and lower flat screen, like on a laptop.

2. The mobile computer according to claim 1, wherein the lower flat screen serves as an input surface in mode b.

3. The mobile computer according to claim 2, wherein a keyboard is displayed on the lower flat screen and serves as the input surface in mode b.

4. The mobile computer according to claim 1, wherein a tangible marking is placed on the lower flat screen as a reference mark for the keyboard.

5. The mobile computer according to claim 1, wherein the casing parts can be locked in various positions relative to each other.

6. The mobile computer according to claim 5, wherein it can be locked preferably in two positions for mode a, encompassing a 180 degree opening relative to the flat/planar condition, or approx. 135 degree opening for use as a book.

7. The mobile computer according to claim 1, wherein the two flat screens have different input technologies.

8. The mobile computer according to claim 7, wherein a flat screen has a technology suitable for input via the fingers, and a flat screen has a technology suitable for input via a pen.

9. The mobile computer according to claim 8, wherein the one technology is a resistive technology in 4, 5 or 8-wire configuration for input via the fingers or any other object, and the other is a capacitive technology for input via a pen.

10. The mobile computer according to claim 1, wherein means are provided for a preferably replaceable battery, in which the battery is inserted via a flip frame concept that makes it possible to operate any devices, such as optical or magnetic drives, as well as an additional battery.

11. The mobile computer according to claim 1, wherein the two displays can be controlled and adjusted independently of each other, wherein the control actions take place based on one or more of the following criteria: horizontal orientation; vertical orientation; standby state; on/off; background setting; contrast; brightness.

12. The mobile computer according to claim 1, wherein an integrated system bus interface is provided for using a docking station with external devices or communication services.

13. The mobile computer according to claim 1, wherein means are provided integrated communication functions, which can be selected from among the following: WLAN, WIMAX, GPRS, UMTS, GSM, Bluetooth, Ethernet, infrared, USB.

14. The mobile computer according to claim 1, wherein the internal computer components are distributed on the casing parts by space and weight criteria.

15. The mobile computer according to claim 14, wherein the heavy components are arranged in the lower casing side in the case of mode b, so that the computer does not tend to tilt.

16. The mobile computer according to claim 1, wherein the heavy components are arranged in the lower area in the case of mode a, so that the device stands or rests in the hands in a more stable manner.

17. The mobile computer according to claim 1, wherein the heavy components are batteries, hard disks and optical DVD drives.

18. The mobile computer according to claim 1, wherein a telephone is integrated in one of the casing parts, wherein the telephone is designed as a chip on the motherboard with an additional display in the cover, or is a mobile telephone inserted into the outer cover, which is connected by an insertion slot with the PC, and can be used for telecommunication services.

19. The mobile computer according to claim 18, wherein means are present to play back audio or video files in the display variant even without starting up the operating system, and to show them on the display, with a separate CPU, RAM, flash-RAM preferably being required.

20. The mobile computer according to claim 1, wherein means are present to effect control in such a way that new windows of an application are automatically opened in the second screen in mode a.

21. The mobile computer according to claim 1, wherein the hardware, in particular the graphics card, is configured in such a way that two logical computers can run, with each computer being assigned its own screen.
